(19) United States
(12) Patent Application Publication
(10) Pub. No.: US 2025/0038643 A1
(43) Pub. Date: Jan. 30, 2025

(54) SWITCHING CONTROL UNIT, SWITCHING POWER SUPPLY APPARATUS, AND ELECTRIC POWER SUPPLY SYSTEM

(71) Applicant: TDK CORPORATION, Tokyo (JP)

(72) Inventor: Makoto SATO, Tokyo (JP)

(73) Assignee: TDK CORPORATION, Tokyo (JP)

(21) Appl. No.: 18/715,907

(22) PCT Filed: Dec. 2, 2021
(86) PCT No.: PCT/JP2021/044270

§ 371 Date: Jun. 3, 2024

(51) Int. Cl. H02M 1/00; H02M 3/00; H02M 3/335

(52) U.S. Cl. CPC H02M 1/0054; H02M 3/01; H02M 3/33571

(57) ABSTRACT

A switching control unit to be applied to a switching power supply apparatus includes a control circuit that controls respective switching operations of switching devices included in at least one of an inverter circuit or a rectifying and smoothing circuit. Based on a result of detection of a current flowing to pass through a capacitive component between a gate and a drain of a first switching device as one of the switching devices that is in an OFF state, the control circuit performs timing setting of a switching timing for the first switching device from the OFF state to an ON state. The switching timing is to come after a shift to a delay time occurring upon switching of a second switching device as another one of the switching devices from an ON state to an OFF state.

### TECHNICAL FIELD

The disclosure relates to a switching power supply apparatus that performs voltage conversion using switching devices, to a switching control unit to be applied to such a switching power supply apparatus, and to an electric power supply system including such a switching power supply apparatus.

### BACKGROUND ART

Various DC-DC converters have been proposed and put into practical use as an example of switching power supply apparatuses (see Patent Literature 1, for example). The DC-DC converter of this kind typically includes an inverter circuit, a power conversion transformer, and a rectifying and smoothing circuit. The inverter circuit includes a switching device.

### CITATION LIST

### Patent Literature

Patent Literature 1: Japanese Patent No. 4929856

### SUMMARY

A switching control unit according to an example embodiment of the disclosure is to be applied to a switching power supply apparatus. The switching power supply apparatus includes a transformer, an inverter circuit, and a rectifying and smoothing circuit. The transformer includes a primary winding and a secondary winding. The inverter circuit is disposed between the primary winding and a pair of input terminals to which an input voltage is to be inputted. The rectifying and smoothing circuit is disposed between the secondary winding and a pair of output terminals from which an output voltage is to be outputted. The switching control unit includes a control circuit configured to control respective switching operations of switching devices included in at least one of the inverter circuit or the rectifying and smoothing circuit. Based on a result of detection of a current flowing to pass through a capacitive component between a gate and a drain of a first switching device as one of the switching devices that is in an OFF state, the control circuit is configured to perform timing setting of a switching timing for the first switching device from the OFF state to an ON state. The switching timing is to come after a shift to a delay time occurring upon switching of a second switching device as another one of the switching devices from an ON state to an OFF state.

A switching power supply apparatus according to an example embodiment of the disclosure includes a pair of input terminals, a pair of output terminals, a transformer, an inverter circuit, a rectifying and smoothing circuit, and a switching control unit. The pair of input terminals are configured to receive an input voltage. The pair of output terminals are configured to output an output voltage. The transformer includes a primary winding and a secondary winding. The inverter circuit is disposed between the primary winding and the pair of input terminals. The rectifying and smoothing circuit is disposed between the secondary winding and the pair of output terminals. The switching control unit includes a control circuit configured to control respective switching operations of switching devices included in at least one of the inverter circuit or the rectifying and smoothing circuit. Based on a result of detection of a current flowing to pass through a capacitive component between a gate and a drain of a first switching device as one of the switching devices that is in an OFF state, the control circuit is configured to perform timing setting of a switching timing for the first switching device from the OFF state to an ON state. The switching timing is to come after a shift to a delay time occurring upon switching of a second switching device as another one of the switching devices from an ON state to an OFF state.

An electric power supply system according to an example embodiment of the disclosure includes a switching power supply apparatus and a power source. The switching power supply apparatus includes a pair of input terminals, a pair of output terminals, a transformer, an inverter circuit, a rectifying and smoothing circuit, and a switching control unit. The pair of input terminals are configured to receive an input voltage. The pair of output terminals are configured to output an output voltage. The transformer includes a primary winding and a secondary winding. The inverter circuit is disposed between the primary winding and the pair of input terminals. The rectifying and smoothing circuit is disposed between the secondary winding and the pair of output terminals. The switching control unit includes a control circuit configured to control respective switching operations of switching devices included in at least one of the inverter circuit or the rectifying and smoothing circuit. Based on a result of detection of a current flowing to pass through a capacitive component between a gate and a drain of a first switching device as one of the switching devices that is in an OFF state, the control circuit is configured to perform timing setting of a switching timing for the first switching device from the OFF state to an ON state. The switching timing is to come after a shift to a delay time occurring upon switching of a second switching device as another one of the switching devices from an ON state to an OFF state. The power source is configured to supply the input voltage to the pair of input terminals.

### BRIEF DESCRIPTION OF THE DRAWINGS

FIG. 1 is a circuit diagram illustrating a schematic configuration example of a switching power supply apparatus according to one example embodiment of the disclosure.

FIG. 2 is a circuit diagram illustrating a detailed configuration example of a control circuit and so forth illustrated in FIG. 1.

FIG. 3 is a timing chart illustrating an operation example of the switching power supply apparatus illustrated in FIG. 1.

FIG. 4 is a diagram illustrating a conduction characteristic example of a transistor.

FIG. 5 is a timing chart for describing a dead time in an ideal state.

FIG. 6 is a timing chart for describing the dead time in a state where a circuit delay time is generated.

FIG. 7 is a timing chart illustrating waveform examples of a detection current and so forth according to one example embodiment.

FIG. 8 is a timing chart illustrating parts of the waveform examples illustrated in FIG. 7 in an enlarged manner.

FIG. 9 is a timing chart illustrating exemplary control of a switching operation according to one example embodiment.

FIG. 10 is a circuit diagram illustrating a configuration example of a control circuit and so forth according to Modification Example 1.

FIG. 11 is a circuit diagram illustrating a configuration example of a control circuit and so forth according to Modification Example 2.

FIG. 12 is a circuit diagram illustrating a configuration example of a control circuit and so forth according to Modification Example 3.

FIG. 13 is a timing chart illustrating waveform examples of a detection voltage and so forth according to Modification Example 3.

FIG. 14 is a timing chart schematically illustrating exemplary control of a switching operation according to Modification Example 4.

FIG. 15 is a circuit diagram illustrating a schematic configuration example of a switching power supply apparatus according to Modification Example 5.

FIG. 16 is a circuit diagram illustrating a schematic configuration example of a switching power supply apparatus according to Modification Example 6.

FIG. 17 is a circuit diagram illustrating a schematic configuration example of a switching power supply apparatus according to Modification Example 7.

### DETAILED DESCRIPTION

It is desired in general that a switching power supply apparatus such as a DC-DC converter reduce electric power loss, that is, achieve high efficiency.

It is desirable to provide a switching control unit, a switching power supply apparatus, and an electric power supply system that each make it possible to reduce electric power loss.

A description is given in detail below of some example embodiments of the disclosure with reference to the drawings. The description is given in the following order.
1. Example Embodiment (an example case of using a center-tap rectifying circuit)
2. Modification Examples
Modification Example 1 (another circuit configuration example of a gate driving circuit in a control circuit)
Modification Examples 2 and 3 (example cases of indirectly detecting a detection current)
Modification Example 4 (an example case where a technique of controlling a switching operation is switchable)
Modification Example 5 (an example case of using a bridge rectifying circuit) Modification Examples 6 and 7 (example cases of employing a synchronous rectifying circuit)
3. Other Modification Examples

### 1. Example Embodiment

### [Configuration]

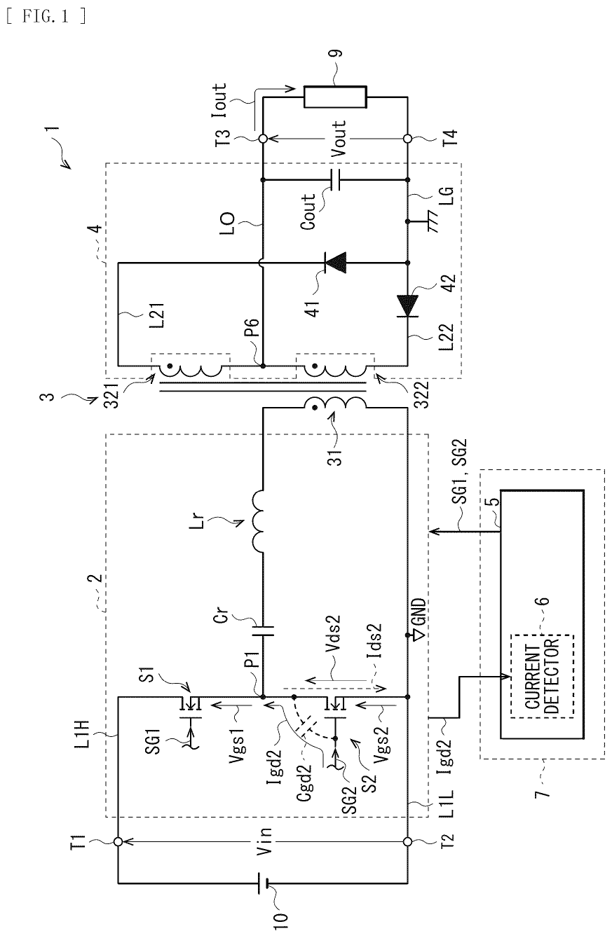

FIG. 1 illustrates a schematic configuration example of a switching power supply apparatus (a switching power supply apparatus 1) according to an example embodiment of the disclosure in a circuit diagram. The switching power supply apparatus 1 serves as a DC-DC converter that performs voltage conversion of a direct-current input voltage Vin supplied from a direct-current input power source 10 (e.g., a battery) into a direct-current output voltage Vout to thereby supply electric power to a load 9. Examples of the load 9 may include electronic equipment and a battery. As described below, the switching power supply apparatus 1 is what is called an “(isolated half-bridge) LLC resonant” DC-DC converter. Note that a mode of the voltage conversion to be performed by the switching power supply apparatus 1 may be either up-conversion (set-up) or down-conversion (step-down).

Here, the direct-current input voltage Vin corresponds to a specific example of an “input voltage” in one embodiment of the disclosure, and the direct-current output voltage Vout corresponds to a specific example of an “output voltage” in one embodiment of the disclosure. The direct-current input power source 10 corresponds to a specific example of a “power source” in one embodiment of the disclosure. A system including the direct-current input power source 10 and the switching power supply apparatus 1 corresponds to a specific example of an “electric power supply system” in one embodiment of the disclosure.

The switching power supply apparatus 1 includes two input terminals T1 and T2, two output terminals T3 and T4, an inverter circuit 2, a transformer 3, a rectifying and smoothing circuit 4, and a control circuit 7. The direct-current input voltage Vin is inputted to between the input terminals T1 and T2. The direct-current output voltage Vout is outputted from between the output terminals T3 and T4. Note that in the example illustrated in FIG. 1, a primary low-voltage line LIL is coupled to a ground GND.

Here, the input terminals T1 and T2 correspond to a specific example of a “pair of input terminals” in one embodiment of the disclosure. The output terminals T3 and T4 correspond to a specific example of a “pair of output terminals” in one embodiment of the disclosure. The control circuit 7 corresponds to a specific example of a “switching control unit” in one embodiment of the disclosure.

Note that an input smoothing capacitor, for example, may be disposed between a primary high-voltage line LIH coupled to the input terminal T1 and the primary low-voltage line LIL coupled to the input terminal T2. Specifically, at a location between the inverter circuit 2 to be described later and the input terminals T1 and T2, a first end (one end) of the input smoothing capacitor may be coupled to the primary high-voltage line LIH, and a second end (another end) of the input smoothing capacitor may be coupled to the primary low-voltage line LIL. Such an input smoothing capacitor is a capacitor for smoothing the direct-current input voltage Vin inputted from the input terminals T1 and T2.

### A. Inverter Circuit 2

The inverter circuit 2 is disposed between the input terminals T1 and T2 and a primary winding 31 of the transformer 3 to be described later. The inverter circuit 2 includes two switching devices S1 and S2, a resonant inductor Lr, and a resonant capacitor Cr, thus being what is called a “half-bridge” inverter circuit. Note that the resonant inductor Lr may include a leakage inductance of the transformer 3 to be described later, or may be provided separately from such a leakage inductance.

Here, the switching devices S1 and S2 described above each correspond to a specific example of one of “switching devices” in one embodiment of the disclosure. The switching device S2 corresponds to a specific example of a “first switching device” in one embodiment of the disclosure, and the switching device S1 corresponds to a specific example of a “second switching device” in one embodiment of the disclosure.

Usable as the switching devices S1 and S2 are, for example, various types of switching devices, including field-effect transistors (metal oxide semiconductor-field effect transistors (MOS-FETs)), insulated gate bipolar transistors (IGBTs), or high electron mobility transistors (HEMTs), i.e., heterostructure field-effect transistors (HFETs). Examples of the HEMT include a gallium nitride (GaN) transistor.

In the example illustrated in FIG. 1, the switching devices S1 and S2 each include a transistor that includes a MOS-FET or a HEMT. When MOS-FETs or HEMTs are used as the switching devices S1 and S2 in this way, it is possible for a capacitor and a diode (not illustrated in FIG. 1) that are to be coupled in parallel to each of the switching devices S1 and S2 to respectively include a parasitic capacitance and a parasitic diode of corresponding one of the MOS-FETs or HEMTs.

In the inverter circuit 2, the two switching devices S1 and S2 are coupled in series to each other in this order between the input terminals T1 and T2, i.e., between the primary high-voltage line L1H and the primary low-voltage line LIL. Specifically, the switching device S1 is disposed between the primary high-voltage line L1H and a node P1, and the switching device S2 is disposed between the node P1 and the primary low-voltage line LIL.

Further, the resonant inductor Lr and the resonant capacitor Cr of the inverter circuit 2 and the primary winding 31 of the transformer 3 to be described later are coupled in series to each other between the node P1 and the primary low-voltage line LIL described above. Specifically, in the example of FIG. 1, a first end (one end) of the resonant capacitor Cr is coupled to the node P1, and a second end (another end) of the resonant capacitor Cr is coupled to a first end (one end) of the resonant inductor Lr. A second end (another end) of the resonant inductor Lr is coupled to one end of the primary winding 31 described above, and another end of the primary winding 31 is coupled to the primary low-voltage line LIL.

With such a configuration, in the inverter circuit 2, the switching devices S1 and S2 perform switching operations (ON and OFF operations) in accordance with respective driving signals SG1 and SG2 supplied from a driving circuit 5 in the control circuit 7 to be described later. As a result, the direct-current input voltage Vin applied to between the input terminals T1 and T2 is converted into an alternating-current voltage, and the alternating-current voltage is outputted to the transformer 3 (the primary winding 31).

### B. Transformer 3

The transformer 3 includes the single primary winding 31 and two secondary windings 321 and 322.

In the primary winding 31, a first end (the one end) of the primary winding 31 is coupled to the second end (the other end) of the resonant inductor Lr described above, and a second end (the other end) of the primary winding 31 is coupled to the primary low-voltage line LIL described above.

In the secondary winding 321, a first end of the secondary winding 321 is coupled to a cathode of a rectifying diode 41 to be described later via a coupling line L21 to be described later, and a second end of the secondary winding 321 is coupled to a center tap P6 in the rectifying and smoothing circuit 4 to be described later. In the secondary winding 322, a first end of the secondary winding 322 is coupled to a cathode of a rectifying diode 42 to be described later via a coupling line L22 to be described later, and a second end of the secondary winding 322 is coupled to the center tap P6 described above. In other words, the respective second ends of the secondary windings 321 and 322 are coupled commonly to the center tap P6.

The transformer 3 performs voltage conversion of a voltage generated by the inverter circuit 2, that is, a voltage in the form of a rectangular pulse wave received at the primary winding 31 of the transformer 3, and outputs an alternating-current voltage from the respective ends of the secondary windings 321 and 322. Note that a degree of the voltage conversion of the direct-current output voltage Vout with respect to the direct-current input voltage Vin in this case depends on a turns ratio between the primary winding 31 and the secondary windings 321 and 322, and a switching period Tsw (switching frequency fsw=1/Tsw) to be described later.

### C. Rectifying and Smoothing Circuit 4

The rectifying and smoothing circuit 4 includes the two rectifying diodes 41 and 42 and a single output smoothing capacitor Cout. Specifically, the rectifying and smoothing circuit 4 includes a rectifying circuit including the rectifying diodes 41 and 42, and a smoothing circuit including the output smoothing capacitor Cout.

The rectifying circuit described above is what is called a “center-tap” rectifying circuit. That is, respective anodes of the rectifying diodes 41 and 42 are coupled to a ground line LG, the cathode of the rectifying diode 41 is coupled to the above-described first end of the secondary winding 321 via the coupling line L21, and the cathode of the rectifying diode 42 is coupled to the above-described first end of the secondary winding 322 via the coupling line L22. Further, as described above, the respective second ends of the secondary windings 321 and 322 are coupled commonly to the center tap P6. The center tap P6 is coupled to the output terminal T3 described above via an output line LO. Note that the ground line LG described above is coupled to the output terminal T4 described above.

In the smoothing circuit described above, the output smoothing capacitor Cout is coupled between the output line LO and the ground line LG described above, i.e., between the output terminals T3 and T4. That is, a first end of the output smoothing capacitor Cout is coupled to the output line LO, and a second end of the output smoothing capacitor Cout is coupled to the ground line LG.

In the rectifying and smoothing circuit 4 having such a configuration, the rectifying circuit including the rectifying diodes 41 and 42 rectifies the alternating-current voltage outputted from the transformer 3, and outputs the rectified voltage. Further, the smoothing circuit including the output smoothing capacitor Cout smooths the voltage rectified by the rectifying circuit described above to thereby generate the direct-current output voltage Vout. The direct-current output voltage Vout generated in this way causes a direct-current output current Iout (a load current) to flow into the load 9 described above, thus causing electric power to be supplied to the load 9 from the output terminals T3 and T4.

### D. Control Circuit 7

The control circuit 7 is a circuit that controls the switching power supply apparatus 1. As illustrated in FIG. 1, the control circuit 7 includes a current detector 6 that detects a current Igd2 (a detection current) to be described later.

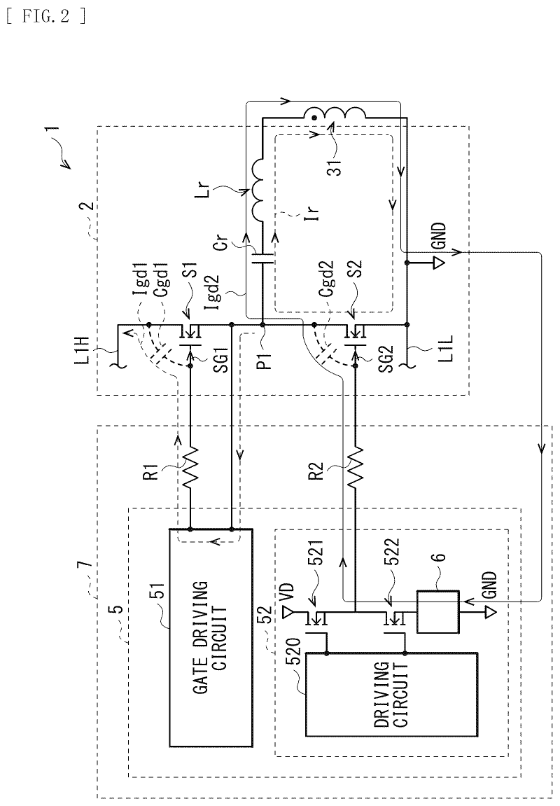

Here, FIG. 2 illustrates a detailed configuration example of the control circuit 7 together with the inverter circuit 2, in a circuit diagram. As illustrated in FIG. 2, the control circuit 7 includes the driving circuit 5 including two gate driving circuits 51 and 52. The current detector 6 described above is disposed in the gate driving circuit 52 out of the gate driving circuits 51 and 52.

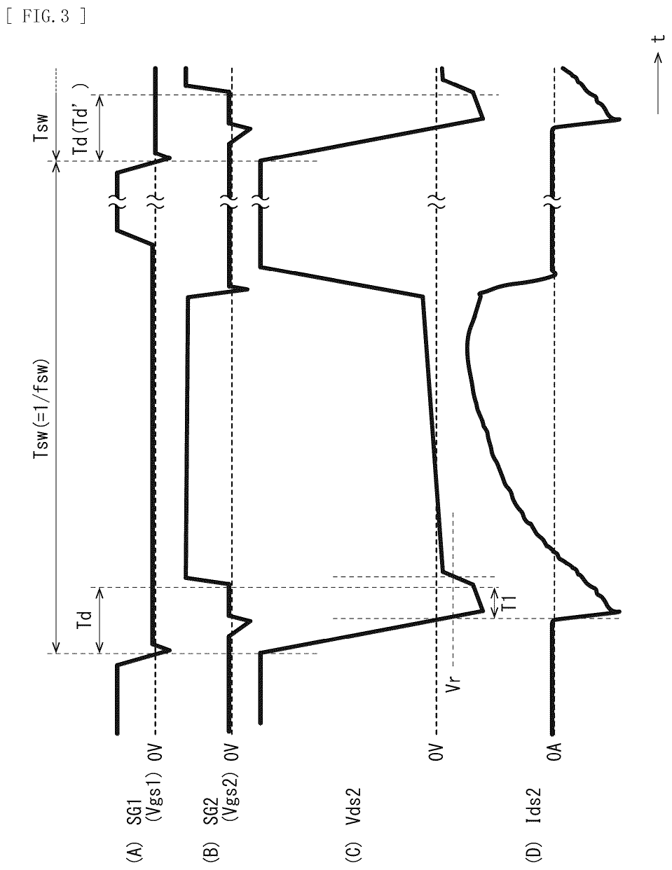

FIG. 3 illustrates an operation example (waveform examples of various voltages and currents) of the switching power supply apparatus 1 in a timing chart. Specifically, part (A) of FIG. 3 illustrates a waveform example of the driving signal SG1 described above (a voltage Vgs1 between a gate and a source of the switching device S1 illustrated in FIG. 1), and part (B) of FIG. 3 illustrates a waveform example of the driving signal SG2 described above (a voltage Vgs2 between a gate and a source of the switching device S2 illustrated in FIG. 1). Part (C) of FIG. 3 illustrates a waveform example of a voltage Vds2 (illustrated in FIG. 1) between a drain and the source of the switching device S2, i.e., a voltage across the switching device S2, and part (D) of FIG. 3 illustrates a waveform example of a current Ids2 (illustrated in FIG. 1) flowing between the drain and the source of the switching device S2. Note that in FIG. 3, a horizontal axis represents time t, and this applies similarly to timing charts described below. FIG. 3 also illustrates a switching period Tsw (=1/fsw) of the switching power supply apparatus 1.

With reference to FIGS. 1 to 3, descriptions are given in detail below of the driving circuit 5 (the gate driving circuits 51 and 52) and the current detector 6 described above.

As illustrated in FIGS. 1 and 2, the driving circuit 5 is a circuit that performs switching driving to control the respective operations of the switching devices S1 and S2 in the inverter circuit 2. Specifically, the driving circuit 5 controls the switching operations, i.e., the ON and OFF operations, of each of the switching devices S1 and S2 by supplying the switching devices S1 and S2 with the respective driving signals SG1 and SG2 independently of each other.

Specifically, as illustrated in FIG. 2, the gate driving circuit 51 in the driving circuit 5 controls the operation of the switching device S1 by supplying the driving signal SG1 to a gate of the switching device S1 via a resistor R1. Note that the resistor R1 described above is coupled between one output terminal of the gate driving circuit 51 and the gate of the switching device S1, and another output terminal of the gate driving circuit 51 is coupled to the above-described node P1 in the inverter circuit 2.

Similarly, as illustrated in FIG. 2, the gate driving circuit 52 in the driving circuit 5 controls the operation of the switching device S2 by supplying the driving signal SG2 to a gate of the switching device S2 via a resistor R2. Further, in the example illustrated in FIG. 2, the gate driving circuit 52 includes a driving circuit 520, two driving transistors 521 and 522, and the above-described current detector 6. The driving transistor 521 has a drain coupled to a power source VD, a gate coupled to one output terminal of the driving circuit 520, and a source coupled to a drain of the driving transistor 522 and one end of the resistor R2. The driving transistor 522 has a gate coupled to another output terminal of the driving circuit 520, and the current detector 6 is disposed between the drain of the driving transistor 522 and the ground GND. Another end of the resistor R2 is coupled to the gate of the switching device S2. With such a configuration, the driving circuit 520 controls the respective operations of the driving transistors 521 and 522 to thereby generate the driving signal SG2 described above.

As illustrated in FIG. 2, the current detector 6 is coupled to the above-described driving transistor 522 in the control circuit 7, i.e., in the above-described gate driving circuit 52 in the driving circuit 5. As illustrated in FIGS. 1 and 2, the current detector 6 is a circuit that detects the current Igd2 flowing along a predetermined path. In the example of FIG. 2, the current detector 6 directly detects the current Igd2. As illustrated in FIG. 2, the current Igd2 is a current flowing to pass through a capacitive component Cdg2 between the gate and the drain of the switching device S2 that is in an OFF state. Further, as indicated by a solid line in FIG. 2, the current Igd2 is a loop current flowing to pass through, in addition to such a capacitive component Cdg2, the resonant capacitor Cr and the resonant inductor Lr in the inverter circuit 2, the primary winding 31 of the transformer 3, the ground GND, the current detector 6, the driving transistor 522, and the resistor R2 one by one in this order. Furthermore, the current Igd2 is a current flowing in association with a resonant current flowing in the inverter circuit 2 as indicated by a broken line in FIG. 2. Note that the capacitive component Cdg2 described above includes, for example, a parasitic capacitance of the switching device S2 or an external capacitor provided to the switching device S2.

Such a current detector 6 includes, for example, a resistor, a Hall element, or the like. In the example illustrated in FIG. 2, the current detector 6 is disposed on a source side of the driving transistor 522. However, the current detector 6 may be disposed on a drain side of the driving transistor 522, for example.

Here, the driving circuit 5 described above performs switching frequency control in controlling the switching operations of each of the switching devices S1 and S2, that is, in performing the switching driving on each of the switching devices S1 and S2. That is, the driving circuit 5 performs pulse frequency modulation (PFM) control on the driving signals SG1 and SG2.

Further, the driving circuit 5 performs the above-described switching driving to cause the switching devices S1 and S2 to perform the switching operations with respective fixed duty ratios and to cause the switching frequency fsw to be variable. In this connection, where ON periods of the switching devices S1 and S2 are denoted as Ton1 and Ton2, respectively, the duty ratios of the switching devices S1 and S2 described above are expressed as (Ton1/Tsw) and (Ton2/Tsw), respectively, using the switching period Tsw (=1/fsw). Further, the (Ton1/Tsw) and (Ton2/Tsw) are each set to a value less than 50%, and a dead time Td to be described later is thus provided between the ON periods Ton1 and Ton2 to prevent short-circuit damage resulting from simultaneous ON periods.

Here, when performing the switching driving described above, the control circuit 7 (the driving circuit 5) also performs the following control, based on a result of detection of the current Igd2 by the current detector 6 described above. That is, based on the result of detection of the current Igd2, the control circuit 7 performs timing setting of a length of the dead time Td as a delay time to be described later, i.e., a switching timing for the switching device S2 from the OFF state to an ON state to be described later, as needed. In other words, the control circuit 7 controls each of the respective switching operations of the switching device S2, based on the dead time Td set through the timing setting in this way.

As illustrated in FIG. 3, for example, the dead time Td is a period from a time point of switching of the switching device S1 from an ON state where the voltage Vgs1 is, for example, 5 V (Vgs1=5 V) to an OFF state where the voltage Vgs1 is 0 V (Vgs1=0 V) to a time point of switching of the switching device S2 from the OFF state to the ON state. That is, the dead time Td is a period in which both of the two switching devices S1 and S2 are set to the OFF state. Note that the term “ON state” of the above-described switching device used herein refers to a gate-ON state of the switching device, and this applies similarly to the following.

In this way, the control circuit 7 performs the timing setting of the switching timing for the switching device S2 from the OFF state to the ON state, based on the result of detection of the current Igd2. The switching timing is to come after the shift to the dead time Td occurring upon the switching of the switching device S1 from the ON state to the OFF state.

Note that such a dead time Td corresponds to a specific example of a “delay time” in one embodiment of the disclosure.

Further, as illustrated in FIG. 3, for example, based on the dead time Td set through the timing setting in this way (e.g., a dead time Td′ illustrated in FIG. 3), the control circuit 7 performs the switching operation in a subsequent switching period Tsw. At this time, the control circuit 7 performs control to shorten such a dead time Td to approximately zero (0), for example, as will be described in detail later.

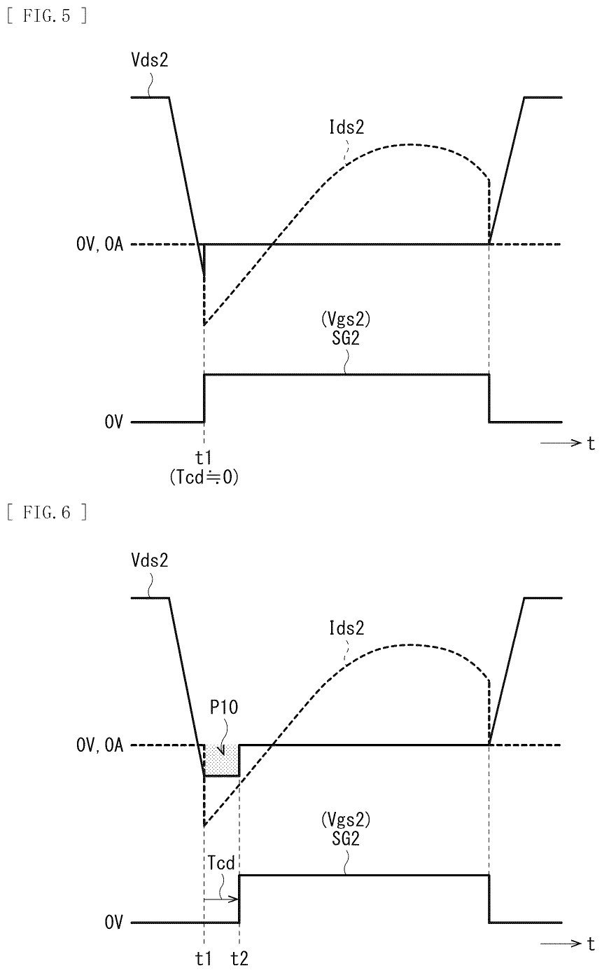

Note that the technique of setting such a dead time Td, i.e., the above-described switching timing for the switching device S2 to the ON state, will be described in detail later with reference to FIGS. 5 to 9.

### [Operation, Workings, and Effects]

### A. Basic Operation

In the switching power supply apparatus 1, the direct-current input voltage Vin supplied from the direct-current input power source 10 via the input terminals T1 and T2 is switched by the switching devices S1 and S2 at the inverter circuit 2 to generate a voltage in the form of a rectangular pulse wave. The voltage in the form of a rectangular pulse wave is supplied to the primary winding 31 of the transformer 3 and is transformed by the transformer 3. Thus, an alternating-current voltage resulting from the transformation is outputted from the secondary windings 321 and 322.

In the rectifying and smoothing circuit 4, the alternating-current voltage outputted from the transformer 3, i.e., the alternating-current voltage resulting from the transformation described above, is rectified by the rectifying diodes 41 and 42 in the rectifying circuit, and is thereafter smoothed by the output smoothing capacitor Cout in the smoothing circuit. The direct-current output voltage Vout is thus outputted from the output terminals T3 and T4. The direct-current output voltage Vout causes the direct-current output current Iout to flow into the load 9, and causes electric power to be supplied to the load 9.

### B. Conduction Characteristic of Transistor

An existing typical switching power supply apparatus including a transistor as a switching device can raise the following concerns.

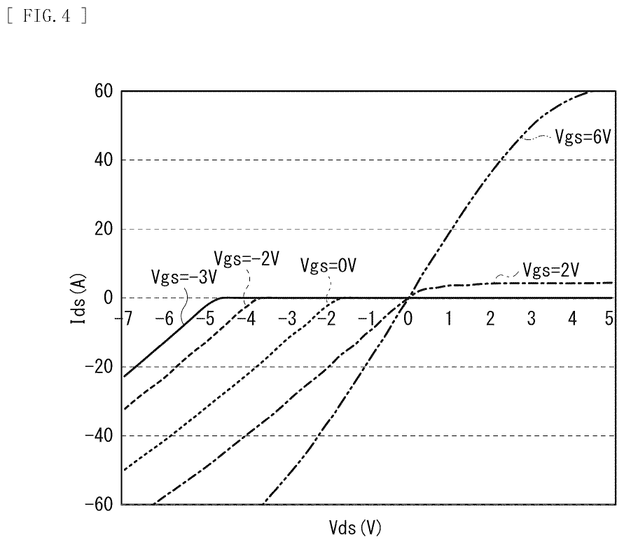

In the dead time Td described above, a reverse voltage drop of, for example, 2 V or greater occurs between a drain and a source of the transistor as a switching device. Such a reverse voltage and a drain current flowing in the transistor cause an occurrence of a conduction loss of the switching device. In particular, when the GaN transistor described above is used as a switching device, the reverse voltage drop becomes large as illustrated in, for example, FIG. 4 described below, and the conduction loss also becomes large accordingly.

FIG. 4 illustrates a conduction characteristic example of a typical transistor, i.e., an example of a correspondence relation of a voltage Vds between the drain and the source with a current Ids flowing between the drain and the source in the case of using the GaN transistor described above. Note that in the example of FIG. 4, respective conduction characteristic examples are illustrated for cases with voltages Vgs between the gate and the source of −3 V, −2 V, 0 V, 2 V, and 6 V.

First, such a GaN transistor has a device structure in which no body diode is incorporated. However, the GaN transistor will have a pseudo body diode in a circuit operation of the GaN transistor. When the above-described voltage Vds becomes a negative voltage while the gate of the GaN transistor is in the OFF state, the pseudo body diode operates upon an occurrence of channel conduction caused by the voltage Vgd between the gate and the drain becoming a positive voltage and exceeding a predetermined threshold. Accordingly, the GaN transistor has a forward drop voltage (VF) of approximately 2 V, which is higher than a VF of a body diode in a silicon MOS-FET, i.e., 0.7 V.

When the voltage Vgs of the GaN transistor is a negative voltage, the VF becomes higher, as illustrated in FIG. 4, for example. Such a high VF results in an occurrence of a larger conduction loss if a conduction period of the pseudo body diode is long and the above-described current Ids is large.

Here, when synchronous rectification or zero-voltage switching (ZVS) is performed, electric conduction of the body diode or the pseudo body diode in the switching device occurs immediately before the switching device is gated on.

Immediately before the switching device is turned on, it is ideal that the switching device be gated on at the same time as when the above-described voltage Vds becomes a negative voltage. Specifically, as illustrated in FIG. 5, for example, in a case of the switching power supply apparatus 1 of the example embodiment, it is ideal that the switching device S2 be switched from the OFF state to the ON state by the driving signal SG2, i.e., by the above-described voltage Vgs2, at a timing t1 when the above-described voltage Vds2 becomes less than zero (i.e., when Vds2<0 is satisfied).

If the switching device is turned on too early, such a turn-on operation can cause a short circuit of electric charge accumulated in an output capacitance Coss of the switching device, which results in an occurrence of electric power loss occurs, or the timing of such a turn-on operation can overlap an ON period of another switching device, which causes a through current to flow.

In contrast, if the switching device is turned on too late, the conduction period of the body diode or the pseudo body diode is prolonged. Specifically, as illustrated in FIG. 6, for example, in the case of the switching power supply apparatus 1 of the example embodiment, if the timing (e.g., a timing t2) at which the switching device S2 is switched from the OFF state to the ON state by the driving signal SG2, i.e., the voltage Vgs2, is too delayed with respect to the timing t1 at which the voltage Vds2 becomes less than zero (Vds2<0), the conduction period of the body diode or the pseudo body diode is prolonged as described above, and accordingly, an increased electric power loss results from such electric conduction, as indicated by a reference sign P10 in FIG. 6, for example.

Further, the voltage Vds rapidly lowers immediately before the switching device is turned on. This can cause a current to flow to the gate of the switching device through a feedback capacitance, causing the voltage Vgs to become a negative voltage. For example, in the GaN transistor, the VF becomes high due to the voltage Vgs being a negative voltage, which increases the electric power loss resulting from the electric conduction of the pseudo body diode.

Further, an appropriate timing of the turn-on operation differs depending on an operating condition, such as an input voltage or a load, of the switching power supply apparatus, and variations in a constant of a parasitic capacitance or an inductance of the switching power supply apparatus. Thus, in order to avoid a fatal increase in electric power loss and an occurrence of a surge or a noise caused by the turn-on operation performed too early, it is desirable that the timing of the turn-on operation be set to a timing later than an ideal timing.

However, the dead time Td can be prolonged by the presence of a circuit delay time Tcd illustrated in FIG. 6, for example. The circuit delay time Tcd is, for example, a delay time in the control circuit 7 resulting from a delay in detection of the current Igd2 by the current detector 6 and a delay of a response time in the driving circuit 5. Ideally, as illustrated in FIG. 5, for example, it is desirable that the switching device S2 be turned on at substantially the same time as the timing t1 at which the voltage Vds2 is detected to be less than zero (Vds2<0). In other words, it is desirable that the circuit delay time Ted be approximately equal to zero (Tcd≈0). However, in reality, the circuit delay time Tcd described above exists as illustrated in FIG. 6, for example. This prolongs the dead time Td, leading to an increase in electric power loss.

Such a circuit delay time Ted is generally about several tens of nanoseconds [ns] at most, but is non-negligible from a viewpoint of recent development of higher frequency control circuits (driving circuits). Specifically, for example, even when the circuit delay time Tcd is about 50 [ns] in the operation of the switching device at, for example, 1 [MHz], electric power loss resulting from such a circuit delay time Ted can sometimes reach as much as 30% of the entire electric power loss in the switching device.

Thus, in an existing typical switching power supply apparatus in which a transistor is included as a switching device, the occurrence of the reverse voltage in the switching device or the like can result in an increase in electric power loss. It is therefore desired to minimize the dead time Td by appropriately setting the timing to turn on the switching device described above and the like.

To achieve cost reduction, enhanced versatility, enhanced speed, and the like of the switching power supply apparatus, it is essential to avoid high-voltage processing (high-withstand-voltage processing) in a detector used in setting the dead time Td. A reason for this is as follows. It is possible to reduce the circuit delay time Ted described above by directly detecting the above-described voltage Vds and thereby setting the dead time Td. However, because of the voltage Vds being a very high voltage of, for example, about 400 V, direct detection of such a voltage Vds involves the high-voltage processing. In this case, for example, an approach of dividing the voltage Vds with a resistor is conceivable; however, in such a case also, concerns eventually arise about a withstand voltage of the resistor, electric power loss in the resistor, etc. In this case, for example, an approach of preventing electric power loss with a diode is further conceivable. However, in such a case also, a concern eventually arises about a withstand voltage of the diode. In addition, in these cases, a time constant is increased by a high impedance of the resistor and parasitic capacitances of the detector and the diode, which eventually results in an increase in circuit delay time.

### C. Operation Example of Example Embodiment

To address these issues, in the switching power supply apparatus 1 of the example embodiment, as described in detail below, the control circuit 7 sets the above-described switching timing for the switching device S2 in advance, at a time point in a pre-stage to be described later, based on the result of detection of the current Igd2 described above. That is, based on the result of detection of the current Igd2 described above, i.e., the current flowing to pass through the capacitive component Cdg2 between the gate and the drain of the switching device S2 that is in the OFF state, the control circuit 7 performs the timing setting of the switching timing for the switching device S2 from the OFF state to the ON state. The switching timing is to come after the shift to the dead time Td.

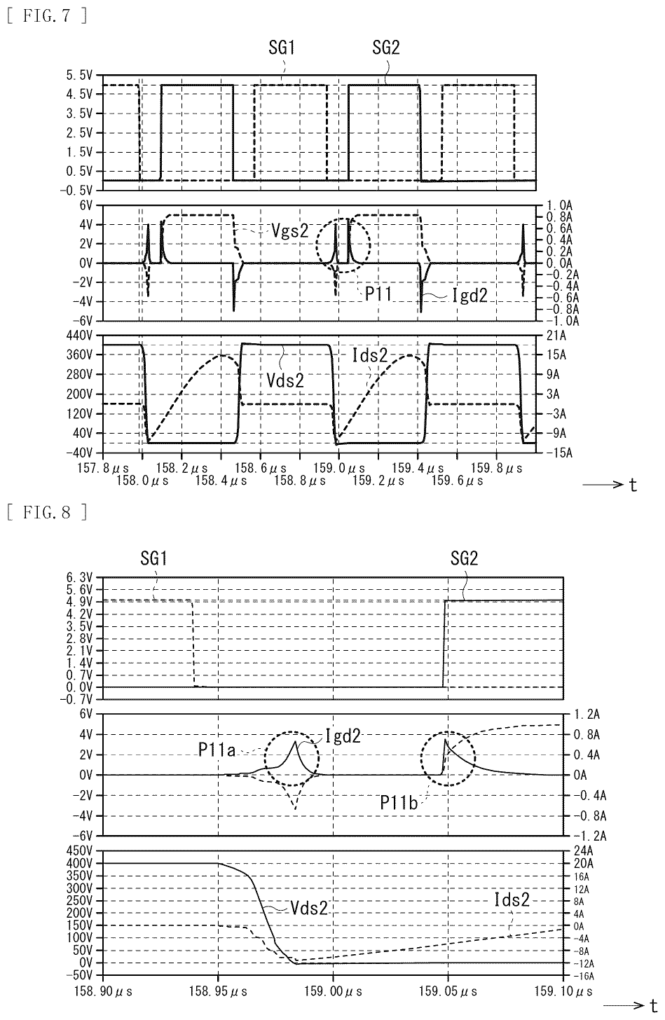

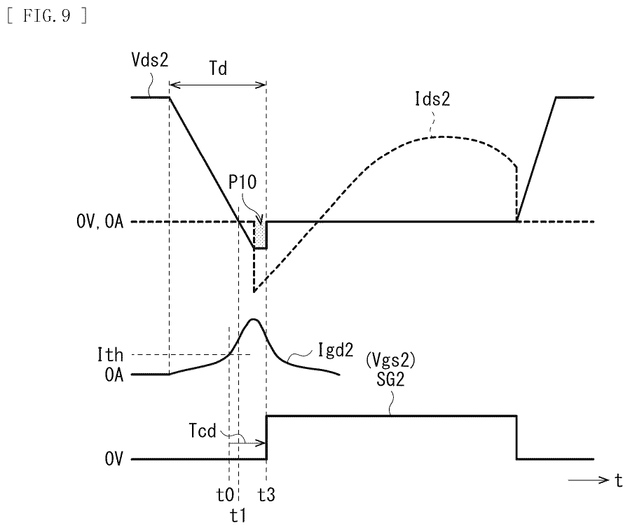

Here, FIG. 7 illustrates a waveform example of the current Igd2 (the detection current) described above and so forth according to the example embodiment in a timing chart. FIG. 8 illustrates parts of the waveform examples illustrated in FIG. 7 in a timing chart in an enlarged manner. Specifically, FIGS. 7 and 8 each illustrate respective waveform examples of the driving signals SG1 and SG2, the voltage Vgs2, the current Igd2, the voltage Vds2, and the current Ids2 described above. FIG. 9 illustrates exemplary control of the switching operation, i.e., exemplary setting of the above-described dead time Td according to the example embodiment in a timing chart.

First, when the driving signal SG1 is switched to the OFF state (i.e., decreases to 0 V), the voltage Vds2 of the switching device S2 lowers accordingly. At this time, to lower the voltage Vds2 of the switching device S2, the above-described current Igd2, i.e., the current flowing to pass through the capacitive component Cdg2 of the switching device S2 that is in the OFF state, is caused to flow by the above-described capacitive component Cdg2 between the gate and the drain of the switching device S2. Further, as indicated by a reference sign P11 in FIG. 7 and a reference sign P11a out of the reference sign P11a and a reference sign P11b in FIG. 8, for example, the current Igd2 tends to increase in the pre-stage before the voltage Vds2 reaches the lowest point. Thus, using the detection of such a current Ids2 as a trigger makes it possible to detect in advance a sign or an event of the voltage Vds2 reaching the lowest point. Further, a gate terminal of the switching device S2 has a withstand voltage of about several tens of volts [V], which eliminates the need for the high-voltage processing described above to detect the current Igd2.

Accordingly, in the example embodiment, the control circuit 7 performs the timing setting of the dead time Td, i.e., the above-described switching timing for the switching device S2 to the ON state, using the result of detection of the current Igd2 described above, in the following way.

That is, based on the detection timing of the current Igd2, the control circuit 7 detects in advance the event of the voltage Vds2 of the switching device S2 reaching the lowest point, in the pre-stage that is before the voltage Vds2 reaches the lowest point after the shift to the dead time Td. At the time point when such an event is detected in advance, the control circuit 7 sets in advance the switching timing for the switching device S2 from the OFF state to the ON state.

Now, a specific description will be given with reference to an example in FIG. 9. In the pre-stage before the voltage Vds2 becomes less than zero (Vds2<0; timing t1) and reaches the lowest point, the above-described current detector 6 may detect, at a timing t0, that the current Igd2 has reached a predetermined threshold current Ith or above (Igd2≥Ith). In such a case, the control circuit 7 determines that an event of the voltage Vds reaching the lowest point has been detected in advance, and sets the switching timing for the switching device S2 from the OFF state to the ON state in advance prior to the timing t1 described above, at the time point (the timing t0) when such an event has been detected in advance. Specifically, the control circuit 7 makes the setting to cause the driving signal SG2 of the switching device S2 to be switched from the OFF state where the voltage Vgs2 is 0 V (Vgs2=0 V) to the ON state where the voltage Vgs2 is, for example, 5 V (Vgs2=e.g., 5V). As a result, as illustrated in FIG. 9, for example, after a lapse of the actual circuit delay time Tcd illustrated in FIG. 9, the driving signal SG2 is actually switched to the ON state, and the switching device S2 is switched from the OFF state to the ON state (i.e., the dead time Td ends).

In this way, the control circuit 7 sets in advance the switching timing for the switching device S2 to the ON state, using the detection timing of the current Igd2. This achieves the following control. That is, as illustrated in FIG. 9, for example, the control circuit 7 reduces the circuit delay time Ted from the detection of the current Igd2 to the switching of the switching device S2 to the ON state, to thereby shorten the dead time Td. More specifically, the control circuit 7 shortens the dead time Td to approximately zero (0) by reducing and adjusting the circuit delay time Ted in this way. This suppresses an increase in electric power loss caused by the prolonged circuit delay time Ted described above, as indicated by the reference sign P10 in FIG. 9, for example.

### D. Workings and Effects

In the example embodiment, as described above, the timing setting of the switching timing for the switching device S2 from the OFF state to the ON state is performed based on the result of detection of the current Igd2 described above. The switching timing is to come after the shift to the dead time Td. Accordingly, the event of the voltage Vds2 of the switching device S2 reaching the lowest point is detectable in advance in the pre-stage before the voltage Vds2 of the switching device S2 reaches the lowest point, as described above, which makis it possible to substantially reduce the circuit delay time Tcd described above. This makes it possible to shorten the dead time Td and reduce the conduction loss of the above-described body diode of the switching device S2. As a result, it is possible in the example embodiment to reduce electric power loss of the switching power supply apparatus 1, i.e., to achieve higher efficiency of the switching power supply apparatus 1.

The description in the example embodiment has been given of the case where the timing setting of the switching timing for the switching device S2 is performed based on the result of detection of the current Igd2 described above. However, for example, timing setting of a switching timing for the switching device S1 from the OFF state to the ON state may be performed based on a result of detection of a current Igd1 as described below. That is, in place of the above-described current Igd2, i.e., the current flowing to pass through the capacitive component Cdg2 between the gate and the drain of the switching device S2 that is in the OFF state, the current Igd1 described below, for example, may be detected with a current detector independently provided in the gate driving circuit 51, for example. As indicated by a broken line in FIG. 2, for example, the current Igd1 is, for example, a current flowing to pass through the capacitive component Cdg2 between the gate and the drain of the switching device S1 that is in the OFF state, the gate driving circuit 51, and the resistor R1. Note that the above-described capacitive component Cdg1 includes, for example, a parasitic capacitance of the switching device S1 or an external capacitor provided to the switching device S1, as with the capacitive component Cdg2. Even with such a configuration, it is basically possible to obtain effects similar to those of the example embodiment.

In particular, when GaN transistors are used as the switching devices S1 and S2, the reverse voltage drop becomes high as described above. In this case, particularly, the reduced conduction loss in the switching devices S1 and S2 described above greatly helps to reduce the electric power loss of the switching power supply apparatus 1.

Further, in the example embodiment, the high-voltage processing described above is not necessary to detect the current Igd2. That is, the current Igd2 is detectable simply with a low-withstand-voltage device rather than a high-withstand-voltage device. This also makes it possible to achieve cost reduction, enhanced versatility, and enhanced speed of the switching power supply apparatus 1.

Further, in the example embodiment, the rectifying circuit in the rectifying and smoothing circuit 4 is what is called the “center-tap” rectifying circuit. This reduces the number of rectifying devices to two (the rectifying diodes 41 and 42), for example. As a result, it is possible to achieve reductions in size, loss, and costs of the rectifying circuit.

### 2. Modification Example

Next, a description will be given of modification examples (Modification Examples 1 to 7) of the foregoing example embodiment. Note that in the following, the same reference signs are assigned to components the same as those in the example embodiment, and descriptions thereof are omitted as appropriate.

### Modification Example 1

### (Configuration)

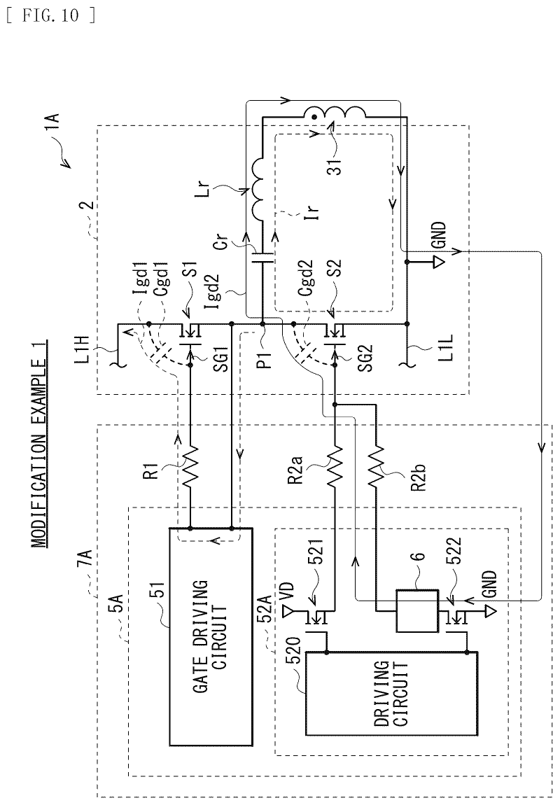

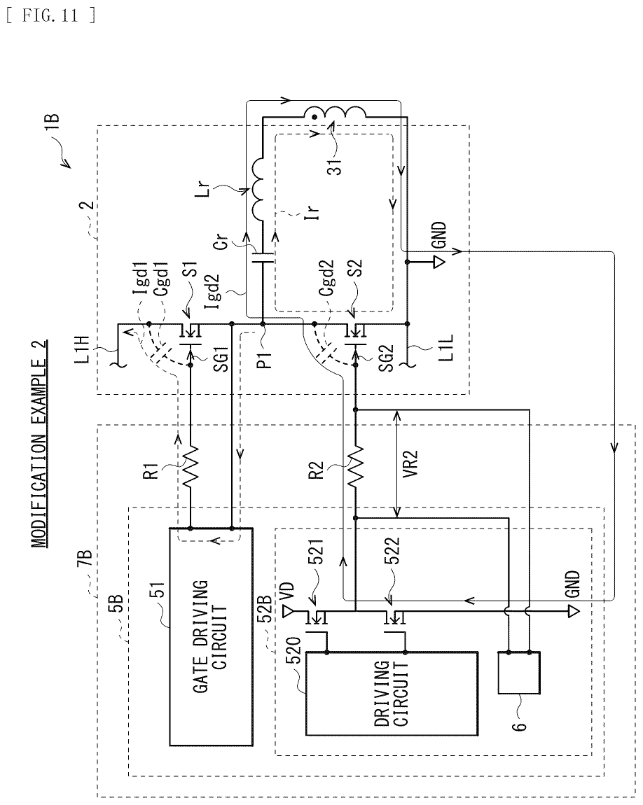

FIG. 10 illustrates a configuration example of a control circuit (a control circuit 7A) in a switching power supply apparatus (a switching power supply apparatus 1A) according to Modification Example 1 together with the inverter circuit 2, in a circuit diagram.

Note that, as in the example embodiment, a system including the direct-current input power source 10 and the switching power supply apparatus 1A corresponds to a specific example of the “electric power supply system” in one embodiment of the disclosure. In addition, the control circuit 7A described above corresponds to a specific example of the “switching control unit” in one embodiment of the disclosure.

The switching power supply apparatus 1A of Modification Example 1 corresponds to the switching power supply apparatus 1 of the example embodiment (see FIG. 1) in which the control circuit 7 is replaced with the control circuit 7A, with the remainder of configuration being unchanged. In addition, the control circuit 7A corresponds to the control circuit 7 of the example embodiment (see FIG. 2) in which the driving circuit 5 including the gate driving circuits 51 and 52 is replaced with a driving circuit 5A including the gate driving circuit 51 and a gate driving circuit 52A, with the remainder of configuration being unchanged.

In the gate driving circuit 52A described above, as illustrated in FIG. 10, an output from the driving circuit 520 is divided by an output terminal on a source side, i.e., a side of the driving transistor 521, and an output terminal on a sink side, i.e., a side of the driving transistor 522. Specifically, in the gate driving circuit 52A, the source of the driving transistor 521 is coupled to the gate of the switching device S2 via a resistor R2a, unlike in the gate driving circuit 52 illustrated in FIG. 2. Further, the drain of the driving transistor 522 is coupled to the gate of the switching device S2 via the current detector 6 and a resistor R2b. That is, in the gate driving circuit 52A, the current detector 6 is disposed on the drain side of the driving transistor 522 rather than the source side of the driving transistor 522, unlike in the gate driving circuit 52.

In Modification Example 1, the current detector 6 detects the current Igd2 indicated by a solid line in FIG. 10. The current Igd2 is a loop current flowing to pass through, in addition to the above-described capacitive components Cdg2 of the switching device S2, the resonant capacitor Cr and the resonant inductor Lr in the inverter circuit 2, the primary winding 31 of the transformer 3, the ground GND, the driving transistor 522, the current detector 6, and the resistor R2b one by one in this order. Further, as in the case of FIG. 2, the current Igd2 is a current flowing in association with a resonant current flowing in the inverter circuit 2 as indicated by a broken line in FIG. 10.

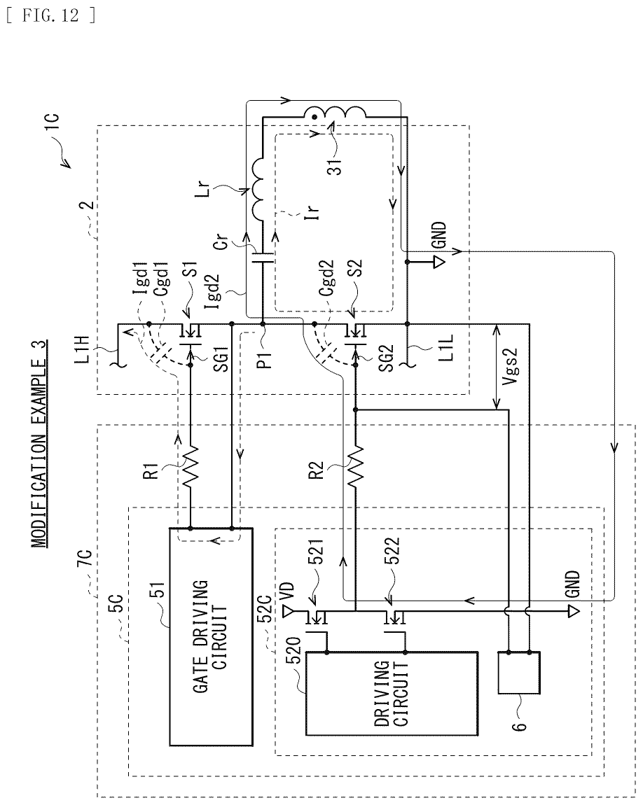

Note that as in the case of FIG. 2, instead of performing the timing setting of the switching timing for the switching device S2, based on the result of detection of the current Igd2 described above, the timing setting of the switching timing for the switching device S1 from the OFF state to the ON state, for example, may be performed based on the result of detection of the above-described current Igd1 indicated by a broken line in FIG. 10, for example. This applies similarly to cases of FIGS. 11 and 12 to be described later.

### (Workings and Effects)

Basically, the switching power supply apparatus 1A of Modification Example 1 having such a configuration is also able to provide effects similar to those of the switching power supply apparatus 1 of the example embodiment, through similar workings. Note that in Modification Example 1, the gate driving circuit 51, for example, may have a configuration similar to that of the gate driving circuit 52A described above.

### Modification Example 2

### (Configuration)

FIG. 11 illustrates a configuration example of a control circuit (a control circuit 7B) in a switching power supply apparatus (a switching power supply apparatus 1B) according to Modification Example 2 together with the inverter circuit 2, in a circuit diagram.

Note that, as in the example embodiment, a system including the direct-current input power source 10 and the switching power supply apparatus 1B corresponds to a specific example of the “electric power supply system” in one embodiment of the disclosure. In addition, the control circuit 7B described above corresponds to a specific example of the “switching control unit” in one embodiment of the disclosure.

The switching power supply apparatus 1B of Modification Example 2 corresponds to the switching power supply apparatus 1 of the example embodiment (see FIG. 1) in which the control circuit 7 is replaced with the control circuit 7B, with the remainder of configuration being unchanged. In addition, the control circuit 7B corresponds to the control circuit 7 of the example embodiment (see FIG. 2) in which the driving circuit 5 including the gate driving circuits 51 and 52 is replaced with a driving circuit 5B including the gate driving circuit 51 and a gate driving circuit 52B, with the remainder of configuration being unchanged.

In the gate driving circuit 52B described above, as illustrated in FIG. 11, the current detector 6 indirectly detects the current Igd2 described above, rather than directly detecting the current Igd2, unlike in the gate driving circuit 52 illustrated in FIG. 2. Specifically, in the example of FIG. 11, the current detector 6 indirectly detects the current Igd2 by detecting a voltage VR2 across the resistor R2 coupled to the gate of the switching device S2, and deriving the current Igd2 from the voltage VR2.

### (Workings and Effects)

Basically, the switching power supply apparatus 1B of Modification Example 2 having such a configuration is also able to provide effects similar to those of the switching power supply apparatus 1 of the example embodiment, through similar workings. Note that in Modification Example 2, the gate driving circuit 51, for example, may have a configuration similar to that of the gate driving circuit 52B described above.

### Modification Example 3

### (Configuration)

FIG. 12 illustrates a configuration example of a control circuit (a control circuit 7C) in a switching power supply apparatus (a switching power supply apparatus 1C) according to Modification Example 3 together with the inverter circuit 2, in a circuit diagram.

Note that, as in the example embodiment, a system including the direct-current input power source 10 and the switching power supply apparatus 1C corresponds to a specific example of the “electric power supply system” in one embodiment of the disclosure. In addition, the control circuit 7C described above corresponds to a specific example of the “switching control unit” in one embodiment of the disclosure.

The switching power supply apparatus 1C of Modification Example 3 corresponds to the switching power supply apparatus 1 of the example embodiment (see FIG. 1) in which the control circuit 7 is replaced with the control circuit 7C, with the remainder of configuration being unchanged. In addition, the control circuit 7C corresponds to the control circuit 7 of the example embodiment (see FIG. 2) in which the driving circuit 5 including the gate driving circuits 51 and 52 is replaced with a driving circuit 5C including the gate driving circuit 51 and a gate driving circuit 52C, with the remainder of configuration being unchanged.

In the above-described gate driving circuit 52C also, as illustrated in FIG. 12, the current detector 6 indirectly detects the current Igd2 described above, rather than directly detecting the current Igd2, as in the gate driving circuit 52B illustrated in FIG. 11. Specifically, in the example of FIG. 12, the current detector 6 indirectly detects the current Igd2 by detecting the voltage Vgs2 between the gate and the source of the switching device S2.

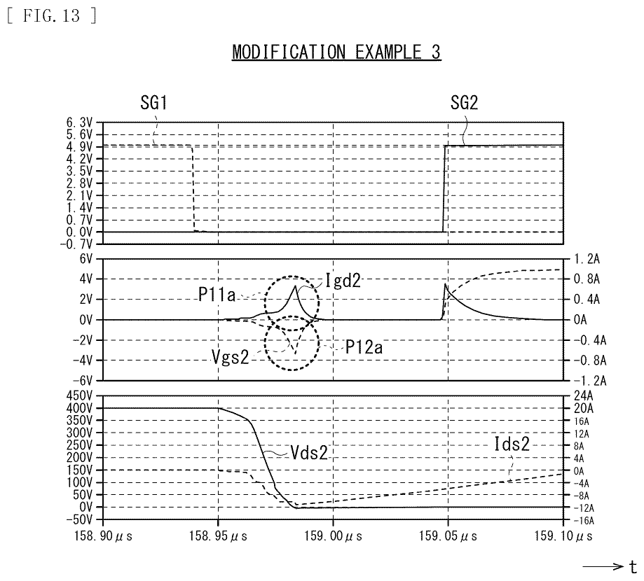

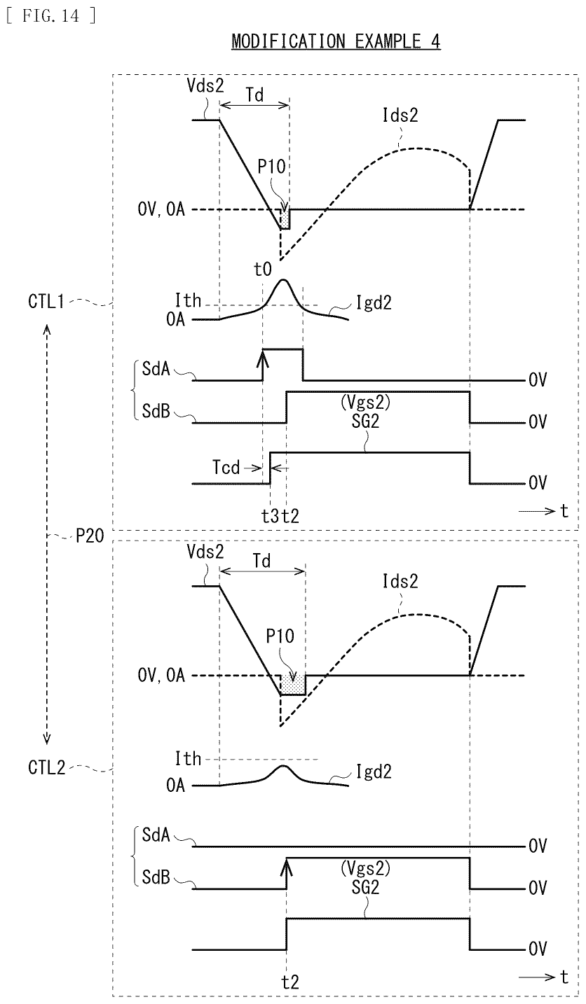

Here, when the current Igd2 increases (see a reference sign P11a) as illustrated in a timing chart of FIG. 13 similar to the timing chart of FIG. 8 described above, for example, the following occurs. That is, owing to coupling of the resistor R2 to the gate of the switching device S2, a negative potential (see a reference sign P12a) of the voltage Vgs2 described above is generated with an increase in the current Igd2, and the negative potential is detectable by the current detector 6. Therefore, using the detection of such a negative potential of the voltage Vgs2 as a trigger makes it possible for the control circuit 7C (the driving circuit 5C) to perform the timing setting of the dead time Td, i.e., the switching timing for the switching device S2 to the ON state, as in the example embodiment.

### (Workings and Effects)

Basically, the switching power supply apparatus 1C of Modification Example 3 having such a configuration is also able to provide effects similar to those of the switching power supply apparatus 1 of the example embodiment, through similar workings. Note that in Modification Example 3, the gate driving circuit 51, for example, may have a configuration similar to that of the gate driving circuit 52C described above.

### Modification Example 4

### (Configuration)

FIG. 14 schematically illustrates exemplary control of a switching operation performed by a control circuit (a control circuit 7D) in a switching power supply apparatus (a switching power supply apparatus 1D) according to Modification Example 4, in a timing chart.

Note that, as in the example embodiment, a system including the direct-current input power source 10 and the switching power supply apparatus 1D corresponds to a specific example of the “electric power supply system” in one embodiment of the disclosure. In addition, the control circuit 7D described above corresponds to a specific example of the “switching control unit” in one embodiment of the disclosure.

The switching power supply apparatus 1D of Modification Example 4 corresponds to the switching power supply apparatus 1 of the example embodiment (see FIG. 1) in which the control circuit 7 is replaced with the control circuit 7D, with the remainder of configuration being unchanged.

As illustrated in FIG. 14, for example, the control circuit 7D executes two kinds of control including control CTL1 and control CTL2 in a switchable manner (see a reference sign P20) in accordance with a detection status of the current Igd2 described above or in accordance with a switching setting by a user or the like.

Although details will be described later, in the control CTL1 (first control), the control circuit 7D performs the timing setting of the switching timing for the switching device S2 to the ON state (i.e., the dead time Td), based on the result of detection of the current Igd2, as described so far. In contrast, in the control CTL2 (second control), the control circuit 7D sets the switching timing for the switching device S2 to the ON state (i.e., the dead time Td) to a fixed timing at all times, as in a typical way.

In this way, the two kinds of control including the control CTL1 and the control CTL2 are executed in the switchable manner in accordance with the detection status of the current Igd2. A reason for this is that a situation can occur in which the current Igd2 is not successfully detectable, depending on, for example, a load condition, an input condition, or the like. That is, a setting malfunction of the dead time Td resulting from a detection failure of the current Igd2 is avoidable by appropriately combining the technique of performing the timing setting of the dead time Td in the manner described so far (i.e., the control CTL1) and the technique of setting the dead time Td to the fixed timing at all times as in a typical way (i.e., the control CTL2).

Specifically, in the example of the control CTL1 illustrated in FIG. 14, a driving signal SdA is switched to an ON state (i.e., a “high (H)” state) first, in a detection period of the current Igd2 in which Igd2≥Ith is satisfied. Note that a timing of switching another driving signal SdB to the ON state (the “H” state), i.e., the timing t2, corresponds to the fixed timing to which the switching timing for the switching device S2 to the ON state is set at all times as in a typical way. Thereafter, in the control CTL1, the control circuit 7D switches the switching device S2 to the ON state as needed after the lapse of the circuit delay time Tcd described above (i.e., at the timing t3), using the time point when the current Igd2 is detected (i.e., the timing t0) as a trigger, as described so far (see FIG. 14). That is, in the control CTL1, the control circuit 7D performs the timing setting of the switching timing for the switching device S2 to the ON state, using the switching timing of the driving signal SdA, out of the two driving signals SdA and SdB described above, to the ON state as the trigger.

In contrast, in the example of the control CTL2 illustrated in FIG. 14, even in a situation where a magnitude of the current Igd2 is insufficient and less than the threshold current Ith, i.e., even in a situation where a state of Igd2<Ith remains as illustrated in FIG. 14, the following is performed. That is, in this situation, the driving signal SdA described above remains in an OFF state (a “low (L)” state). Accordingly, in this control CTL2, the control circuit 7D sets the switching timing for the switching device S2 to the ON state to the timing t2 that is the fixed timing at all times, using the timing of switching the driving signal SdB, out of the two driving signals SdA and SdB described above, to the ON state as a trigger (see FIG. 14).

### (Workings and Effects)

Basically, the switching power supply apparatus 1D of Modification Example 4 having such a configuration is also able to provide effects similar to those of the switching power supply apparatus 1 of the example embodiment, through similar workings.

Further, in Modification Example 4, in particular, the two kinds of control including the control CTL1 and the control CTL2 are executed in the switchable manner in accordance with the detection status of the current Igd2, as described above. Accordingly, it is possible to avoid, for example, the setting malfunction of the dead time Td, i.e., the switching timing for the switching device S2 to the ON state, resulting from the detection failure of the current Igd2. This makes it possible to achieve a more robust system.

### [Modification 5]

### (Configuration)

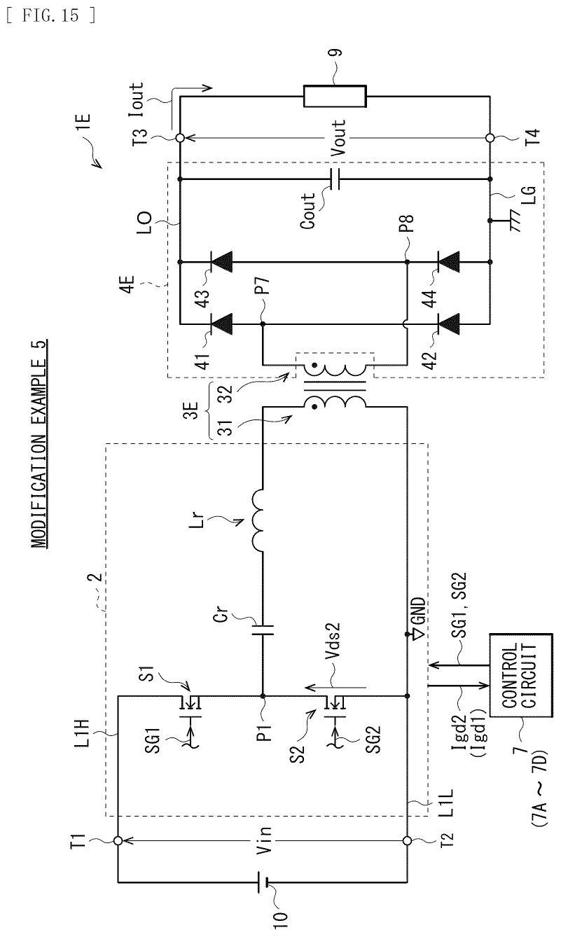

FIG. 15 illustrates a schematic configuration example of a switching power supply apparatus (a switching power supply apparatus 1E) according to Modification Example 5 in a circuit diagram.

Note that, as in the example embodiment, a system including the direct-current input power source 10 and the switching power supply apparatus 1E corresponds to a specific example of the “electric power supply system” in one embodiment of the disclosure.

The switching power supply apparatus 1E of Modification Example 5 corresponds to the switching power supply apparatus 1 of the example embodiment (see FIG. 1) in which the transformer 3 and the rectifying and smoothing circuit 4 are replaced with a transformer 3E and a rectifying and smoothing circuit 4E, respectively, with the remainder of configuration being unchanged. Note that, as illustrated in FIG. 15, for example, in the switching power supply apparatus 1E, the control circuit 7 may be replaced with any one of the control circuits 7A to 7D described in Modification Examples 1 to 4.

The transformer 3E includes the single primary winding 31 and a single secondary winding 32. That is, in contrast to the transformer 3 including the two secondary windings 321 and 322, the transformer 3E includes only the single secondary winding 32. The secondary winding 32 has a first end coupled to a node P7 in the rectifying and smoothing circuit 4E to be described later, and a second end coupled to a node P8 in the rectifying and smoothing circuit 4E.

As with the transformer 3, the transformer 3E also performs voltage conversion of a voltage generated by the inverter circuit 2, that is, a voltage in the form of a rectangular pulse wave, and outputs an alternating-current voltage from an end of the secondary winding 32. Note that the degree of the voltage conversion of the direct-current output voltage Vout with respect to the direct-current input voltage Vin in this case depends on a turns ratio between the primary winding 31 and the secondary winding 32, and the switching frequency fsw described above.

The rectifying and smoothing circuit 4E includes four rectifying diodes 41 to 44 and the single output smoothing capacitor Cout. Specifically, the rectifying and smoothing circuit 4E includes a rectifying circuit including the rectifying diodes 41 to 44, and the smoothing circuit including the output smoothing capacitor Cout. That is, the rectifying and smoothing circuit 4E corresponds to the rectifying and smoothing circuit 4 in which the rectifying circuit is changed in configuration.

The rectifying circuit of Modification Example 5 is what is called a “bridge” rectifying circuit, unlike the rectifying circuit of the example embodiment that is what is called the “center-tap” rectifying circuit. That is, the cathode of the rectifying diode 41 and a cathode of the rectifying diode 43 are each coupled to the output line LO, and the anode of the rectifying diode 41 is coupled to the cathode of the rectifying diode 42 and the above-described first end of the secondary winding 32 at the node P7. Further, the anode of the rectifying diode 42 and an anode of the rectifying diode 44 are each coupled to the ground line LG, and a cathode of the rectifying diode 44 is coupled to an anode of the rectifying diode 43 and the above-described second end of the secondary winding 32 at the node P8.

In the rectifying and smoothing circuit 4E having such a configuration, the rectifying circuit including the rectifying diodes 41 to 44 rectifies the alternating-current voltage outputted from the transformer 3E, and outputs the rectified voltage, as in the rectifying and smoothing circuit 4.

### (Workings and Effects)

Basically, the switching power supply apparatus 1E of Modification 5 having such a configuration is also able to provide effects similar to those of the switching power supply apparatuses 1 and 1A to 1D described so far, through similar workings.

Further, in Modification Example 5, in particular, the rectifying circuit in the rectifying and smoothing circuit 4E is a bridge rectifying circuit. This reduces the number of windings, i.e., the number of secondary windings, in the transformer 3E to one (i.e., the secondary winding 32) that is less than the number of windings in the example embodiment, for example. As a result, it is possible to achieve reductions in size and loss of the transformer 3E.

### Modification Examples 6 and 7

Respective switching power supply apparatuses according to Modification Examples 6 and 7 (i.e., switching power supply apparatuses 1F and 1G) each correspond to any one of the switching power supply apparatuses of the example embodiment and Modification Examples 1 to 5 described so far in which the rectifying circuit in the rectifying and smoothing circuit 4 or 4E is what is called a synchronous rectifying circuit, as described below. Further, in accordance with the provision of such a synchronous rectifying circuit, the switching power supply apparatus 1F of Modification Example 6 includes a control circuit 7F to be described later in place of the control circuits 7 and 7A to 7D of the example embodiment and Modification Examples 1 to 5, and the switching power supply apparatus 1G of Modification Example 7 includes a control circuit 7G to be described later in place of the control circuits 7 and 7A to 7D of the example embodiment and Modification Examples 1 to 5.

### Configuration of Modification Example 6

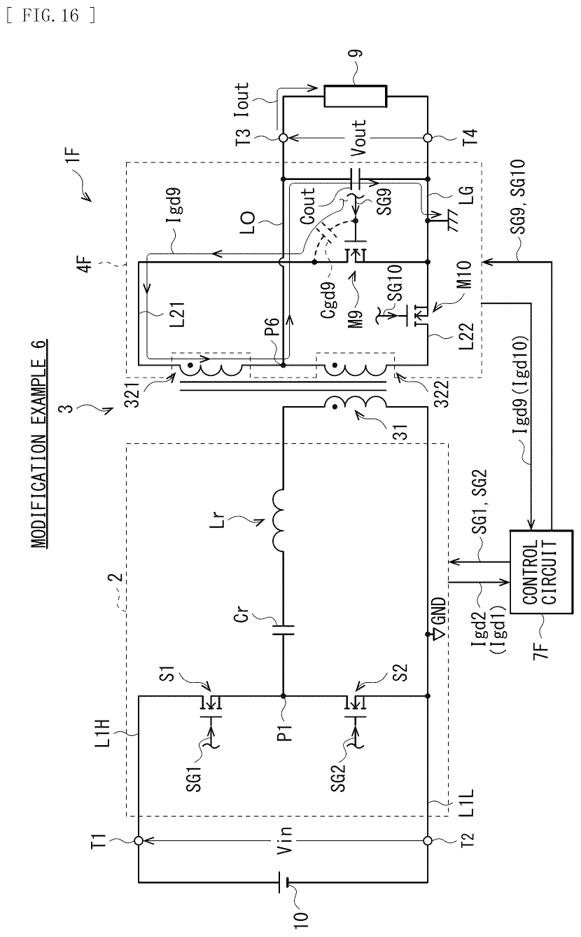

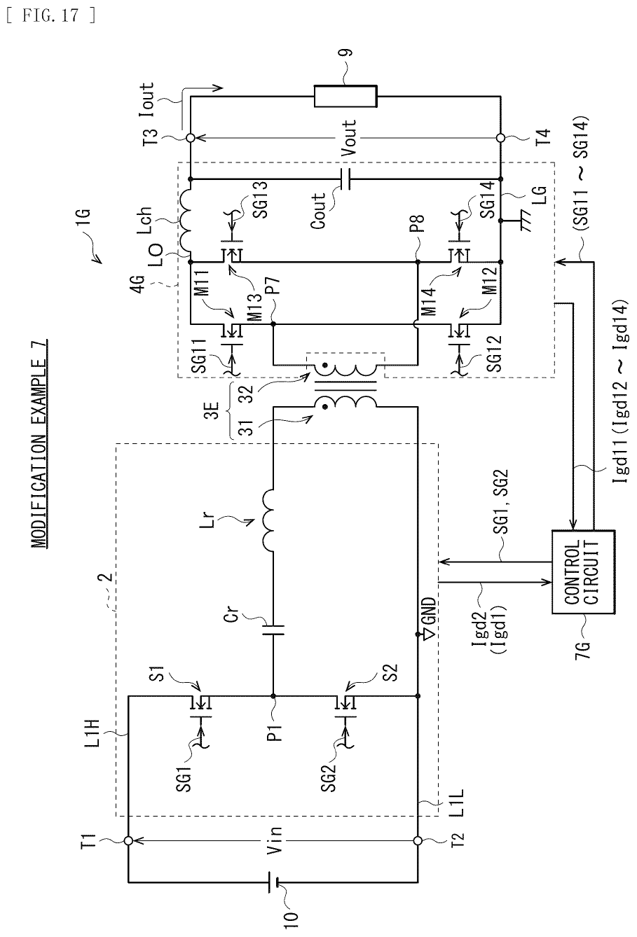

Specifically, FIG. 16 illustrates a schematic configuration example of the switching power supply apparatus 1F according to Modification Example 6 in a circuit diagram.

Note that, as in the example embodiment, a system including the direct-current input power source 10 and the switching power supply apparatus 1F corresponds to a specific example of the “electric power supply system” in one embodiment of the disclosure.

The switching power supply apparatus 1F of Modification Example 6 corresponds to the switching power supply apparatus 1 of the example embodiment in which the rectifying and smoothing circuit 4 and the control circuit 7 are replaced with a rectifying and smoothing circuit 4F and the control circuit 7F, respectively, with the remainder of configuration being unchanged.

In the synchronous rectifying circuit (the rectifying and smoothing circuit 4F) of Modification Example 6, as illustrated in FIG. 16, the rectifying diodes 41 and 42 described in the example embodiment include respective MOS-FETs as switching devices, that is, include MOS transistors M9 and M10, respectively. In the synchronous rectifying circuit, each of the MOS transistors M9 and M10 itself is also controlled to come into an ON state in synchronization with a conduction period of a parasitic diode of corresponding one of the MOS transistors M9 and M10 (i.e., synchronous rectification is performed). Specifically, in Modification Example 6, the driving circuit 5 in the control circuit 7F to be described later controls ON and OFF operations of the MOS transistors M9 and M10, based on respective driving signals SG9 and SG10 (see FIG. 16).

Note that each of the MOS transistors M9 and M10 corresponds to a specific example of a “switching device that performs synchronous rectification” in one embodiment of the disclosure.

Basically, the control circuit 7F of Modification Example 6 has a configuration similar to those of the control circuits 7 and 7A to 7D of the example embodiment and Modification Examples 1 to 5. However, the control circuit 7F differs from the control circuits 7 and 7A to 7D as follows.

That is, first, in the control circuits 7 and 7A to 7D, both of the two switching devices S2 and S1 that are to be subjected to the setting of the dead time Td and that correspond to the “first switching device” and the “second switching device” in the disclosure are the switching devices disposed in the inverter circuit 2. In contrast, in the control circuit 7F, one or both of the two switching devices that are to be subjected to the setting of the dead time Td and that correspond to the “first switching device” and the “second switching device” in the disclosure are one or two switching devices (i.e., one or both of the MOS transistor M9 and the MOS transistor M10 described above) that are disposed in the rectifying and smoothing circuit 4F described above and that perform the synchronous rectification.

Specifically, in the control circuit 7F, (a) or (b) described below is met for the two switching devices that are to be subjected to the setting of the dead time Td, i.e., the above-described switching timing for the switching device to the ON state.
(a) Either the switching device S1 or the switching device S2 and either the MOS transistor M9 or the MOS transistor M10 are the two switching devices that are to be subjected to the setting of the dead time Td.
(b) Both of the MOS transistors M9 and M10 are the two switching devices that are to be subjected to the setting of the dead time Td.

Note that the above-described “two switching devices that are to be subjected to the setting” and that correspond to the “first switching device” and the “second switching device” in the disclosure are, for example, as follows. That is, at the time when one of the switching devices that corresponds to the “second switching device” in the disclosure is being switched from the ON state to the OFF state, if the other switching device is (already) in the OFF state, then the other switching device corresponds to the switching device that is to be subjected to the setting of the switching timing, i.e., the “first switching device” in the disclosure. Thus, if, for example, the other switching device is to be switched from the ON state to the OFF state simultaneously with the switching of the one switching device from the ON state to the OFF state, the other switching device does not correspond to the switching device that is to be subjected to the setting of the switching timing described above.

The control circuit 7F sets the dead time Td, i.e., the above-described switching timing for the switching device to the ON state, for one of the two switching devices that corresponds to the “first switching device” in the disclosure, in a similar manner to that in the example embodiment and Modification Examples 1 to 5. Thereafter, based on the dead time Td of which timing has been set in this way, the control circuit 7F controls the respective switching operations of the switching devices (the switching devices S1 and S2 and the MOS transistors M9 and M10) including the two switching devices described above.

Examples of a current to be detected by the current detector 6 at this time include, in addition to the current Igd2 described above or the current Igd1 described above, a current Igd9 or a current Igd10 described below, as illustrated in FIG. 16, for example.

As indicated by a solid arrow in FIG. 16, the current Igd9 is a current flowing to pass through a capacitive component Cdg9 between a gate and a drain of the MOS transistor M9. The current Igd9 is a loop current flowing to pass through, in addition to such a capacitive component Cdg9, the secondary winding 321, the output smoothing capacitor Cout in the rectifying and smoothing circuit 4F, the ground GND, and the current detector 6 in the control circuit 7F one by one in this order. The current Igd10 is a current flowing to pass through a capacitive component between a gate and a drain of the MOS transistor M10. The current Igd10 is a loop current flowing to pass through, in addition to such a capacitive component, the secondary winding 322, the output smoothing capacitor Cout in the rectifying and smoothing circuit 4F, the ground GND, and the current detector 6 in the control circuit 7F one by one in this order.

Note that such a control circuit 7F corresponds to a specific example of the “switching control unit” in one embodiment of the disclosure. In Modification Example 6, the switching devices S1 and S2 described above correspond to a specific example of the “switching devices” in one embodiment of the disclosure, and the MOS transistors M9 and M10 described above correspond to a specific example of the “switching devices” in one embodiment of the disclosure. Further, any two of the switching devices S1 and S2 and the MOS transistors M9 and M10 (i.e., the two switching devices described above) correspond to a specific example of the “first switching device” and the “second switching device” in one embodiment of the disclosure.

### Configuration of Modification Example 7

FIG. 17 illustrates a schematic configuration example of a switching power supply apparatus 1G according to Modification Example 7 in a circuit diagram.

Note that, as in the example embodiment, a system including the direct-current input power source 10 and the switching power supply apparatus 1G corresponds to a specific example of the “electric power supply system” in one embodiment of the disclosure.

The switching power supply apparatus 1G of Modification Example 7 corresponds to the switching power supply apparatus 1E of Modification Example 5 in which the rectifying and smoothing circuit 4E and the control circuit 7 are replaced with a rectifying and smoothing circuit 4G and the control circuit 7G, respectively, with the remainder of configuration being unchanged.

In the synchronous rectifying circuit (the rectifying and smoothing circuit 4G) of Modification Example 7, as illustrated in FIG. 17, the rectifying diodes 41 to 44 described in Modification Example 5 include respective MOS-FETs as switching devices, that is, include MOS transistors M11 to M14, respectively. In the synchronous rectifying circuit of Modification Example 7 also, as in the synchronous rectifying circuit of Modification Example 6 described above, each of the MOS transistors M11 to M14 itself is also controlled to come into an ON state in synchronization with a conduction period of a parasitic diode of corresponding one of the MOS transistors M11 to M14 (i.e., the synchronous rectification is performed). Specifically, in Modification Example 7, the driving circuit 5 in the control circuit 7G to be described later controls ON and OFF operations of the MOS transistors M11 to M14, based on respective driving signals SG11 to SG14 (see FIG. 17).

Note that each of the MOS transistors M11 to M14 corresponds to a specific example of the “switching device that performs synchronous rectification” in one embodiment of the disclosure.

Basically, the control circuit 7G of Modification Example 7 has a configuration similar to those of the control circuits 7 and 7A to 7D of the example embodiment and Modification Examples 1 to 5. However, as with the control circuit 7F described in Modification Example 6, the control circuit 7G differs from the control circuits 7 and 7A to 7D as follows.

That is, in the control circuit 7G, one or both of the two switching devices that are to be subjected to the setting of the dead time Td and that correspond to the “first switching device” and the “second switching device” in the disclosure are one or two switching devices (i.e., one or two of the MOS transistors M11 to M14 described above) that are disposed in the rectifying and smoothing circuit 4G described above and that perform the synchronous rectification.

Specifically, in the control circuit 7G, (c) or (d) described below is met for the two switching devices that are to be subjected to the setting of the dead time Td, i.e., the above-described switching timing for the switching device to the ON state.
(c) Either the switching device S1 or the switching device S2 and one of the MOS transistors M11 to M14 are the two switching devices that are to be subjected to the setting of the dead time Td.
(d) Two of the MOS transistors M11 to M14 are respectively the two switching devices that are to be subjected to the setting of the dead time Td.

Note that the above-described “two switching devices that are to be subjected to the setting” and that correspond to the “first switching device” and the “second switching device” in the disclosure are, for example, similar to those in Modification Example 6 described above.

The control circuit 7G sets the dead time Td, i.e., the above-described switching timing for the switching device to the ON state, for one of the two switching devices that corresponds to the “first switching device” in the disclosure, in a similar manner to that in the example embodiment and Modification Examples 1 to 6. Thereafter, based on the dead time Td of which timing has been set in this way, the control circuit 7G controls the respective switching operations of the switching devices (the switching devices S1 and S2 and the MOS transistors M11 to M14) including the two switching devices described above.

Examples of a current to be detected by the current detector 6 at this time include, in addition to the current Igd2 described above or the current Igd1 described above, a current Igd11 or currents Igd12 to Igd14 described below, as illustrated in FIG. 17, for example. That is, as with the currents Igd9 and Igd10 described above, the currents Igd11 to Igd14 are each a current flowing to pass through the capacitive component between a gate and a drain of corresponding one of the MOS transistors M11 to M14.

Note that such a control circuit 7G corresponds to a specific example of the “switching control unit” in one embodiment of the disclosure. In Modification Example 7, the switching devices S1 and S2 described above correspond to a specific example of the “switching devices” in one embodiment of the disclosure, and the MOS transistors M11 to M14 described above correspond to a specific example of the “switching devices” in one embodiment of the disclosure. Further, any two of the switching devices S1 and S2 and the MOS transistors M11 to M14 (i.e., the two switching devices described above) correspond to a specific example of the “first switching device” and the “second switching device” in one embodiment of the disclosure. (Workings and Effects of Modification Examples 6 and 7)

Basically, the switching power supply apparatus 1F of Modification Example 6 and the switching power supply apparatus 1G of Modification Example 7 having such respective configurations are also able to provide effects similar to those of the switching power supply apparatuses 1 and 1A to 1E described so far, through similar workings.

Further, in Modification Examples 6 and 7, in particular, the rectifying devices (the rectifying diodes) in the rectifying circuit each include the switching device, and the rectifying circuit is the synchronous rectifying circuit. Such a synchronous rectifying circuit reduces a conduction loss occurring upon rectification. As a result, it is possible to achieve reductions in size and loss of the rectifying circuit. Examples of such a switching device include, in addition to the MOS-FET described above, the HEMT described above, and an IGBT or a bipolar transistor with a diode added thereto in parallel.

### 3. Other Modification Examples

The disclosure has been described above with reference to the example embodiment and the modification examples. However, example embodiments of the disclosure are not limited thereto, and may be modified in a variety of ways.

For example, although specific configurations of the inverter circuit have been described in the foregoing example embodiment, etc., the configurations described in the foregoing example embodiment, etc. are non-limiting examples, and any other configuration may be employed for the inverter circuit, for example. Specifically, for example, regarding how the resonant inductor Lr, the resonant capacitor Cr, and the primary winding 31 coupled in series to each other are arranged with respect to each other, the arrangement relationship described in the example embodiment, etc. is non-limiting. Thus, the resonant inductor Lr, the resonant capacitor Cr, and the primary winding 31 may be arranged in no particular order with respect to each other. Further, although an example case where what is called the “half-bridge” inverter circuit is employed has been described in the foregoing example embodiment, etc., this is a non-limiting example. For example, what is called a “full-bridge” inverter circuit or the like may be employed.

Further, although specific configurations of the transformer (the primary winding and the secondary winding) have been described in the foregoing example embodiment, etc., the configurations described in the foregoing example embodiment, etc. are non-limiting examples, and any other configuration may be employed for the transformer (the primary winding and the secondary winding), for example.

Furthermore, although specific configurations of the rectifying and smoothing circuit (the rectifying circuit and the smoothing circuit) have been described in the foregoing example embodiment, etc., the configurations described in the foregoing example embodiment, etc. are non-limiting examples, and any other configuration may be employed for the rectifying and smoothing circuit (the rectifying circuit and the smoothing circuit), for example. In addition, although specific configurations of the current detector have been described in the foregoing example embodiment, etc., the configurations described in the foregoing example embodiment, etc. are non-limiting examples, and any other configuration may be employed for the current detector, for example. Such a current detector may be provided, for example, outside the control circuit or outside the switching power supply apparatus, rather than inside the control circuit (the switching control unit) or inside the switching power supply apparatus as described in the foregoing example embodiment, etc.

In addition, although the descriptions have been given of the specific techniques by which the driving circuit performs operation control (switching driving) of each of the switching devices in the foregoing example embodiment, etc., the techniques described in the foregoing example embodiment, etc. are non-limiting examples, and any other technique may be employed for the switching driving.

Further, although the DC-DC converter has been described in the foregoing example embodiment, etc. as an example of the switching power supply apparatus according to the disclosure, any embodiment of the disclosure is applicable to any other kind of switching power supply apparatus, such as an AC-DC converter.

Moreover, any two or more of the configuration examples and other examples described so far may be combined and applied in a desired manner.

Embodiments of the disclosure may be configured as follows.

(1)

A switching control unit to be applied to a switching power supply apparatus, the switching power supply apparatus including: a transformer including a primary winding and a secondary winding; an inverter circuit disposed between the primary winding and a pair of input terminals to which an input voltage is to be inputted; and a rectifying and smoothing circuit disposed between the secondary winding and a pair of output terminals from which an output voltage is to be outputted, the switching control unit including
a control circuit configured to control respective switching operations of switching devices included in at least one of the inverter circuit or the rectifying and smoothing circuit, in which
based on a result of detection of a current flowing to pass through a capacitive component between a gate and a drain of a first switching device as one of the switching devices that is in an OFF state, the control circuit is configured to perform timing setting of a switching timing for the first switching device from the OFF state to an ON state, the switching timing being to come after a shift to a delay time occurring upon switching of a second switching device as another one of the switching devices from an ON state to an OFF state.
   (2)

The switching control unit according to (1), in which
the control circuit is configured to
   detect, based on a detection timing of the current, an event of a voltage between a source and the drain of the first switching device reaching a lowest point after the shift to the delay time, in a pre-stage before the voltage reaches the lowest point, and
   perform, at a time point when the event is detected, the timing setting of the switching timing for the first switching device.
      (3)

The switching control unit according to (2), in which, by performing, based on the detection timing of the current, the timing setting of the switching timing for the first switching device to the ON state, the control circuit is configured to reduce a circuit delay time from the detection of the current to switching of the first switching device to the ON state, and thereby shortens the delay time.

(4)

The switching control unit according to (3), in which the control circuit is configured to shorten the delay time to approximately zero by reducing the circuit delay time.

(5)

The switching control unit according to any one of (1) to (4), in which the control circuit is configured to execute first control and second control in a switchable manner in accordance with a status of the detection of the current,
the first control including performing the timing setting of the switching timing for the first switching device, based on the result of the detection of the current,
the second control including setting the switching timing for the first switching device to a fixed timing at all times.
   (6)

The switching control unit according to any one of (1) to (5), further including a current detector configured to directly or indirectly detect the current.

(7)

The switching control unit according to (6), in which the current detector is coupled to a driving transistor in the control circuit.

(8)

The switching control unit according to any one of (1) to (7), in which the capacitive component between the gate and the drain of the first switching device comprises a parasitic capacitance of the first switching device or an external capacitor.

(9)

The switching control unit according to any one of (1) to (8), in which each of the first switching device and the second switching device comprises a switching device that is disposed in the inverter circuit.

(10)

The switching control unit according to any one of (1) to (8), in which at least one of the first switching device or the second switching device comprises a switching device that is disposed in the rectifying and smoothing circuit and that is configured to perform synchronous rectification.

(11)

A switching power supply apparatus including:
the switching control unit according to any one of (1) to (10);
the pair of input terminals;
the pair of output terminals;
the transformer;
the inverter circuit; and
the rectifying and smoothing circuit.
   (12)

An electric power supply system including:
the switching power supply apparatus according to (11); and
a power source configured to supply the input voltage to the pair of input terminals.

The switching control unit, the switching power supply apparatus, and the electric power supply system according to at least one embodiment of the disclosure each make it possible to reduce electric power loss.

1. A switching control unit to be applied to a switching power supply apparatus, the switching power supply apparatus comprising: a transformer including a primary winding and a secondary winding; an inverter circuit disposed between the primary winding and a pair of input terminals to which an input voltage is to be inputted; and a rectifying and smoothing circuit disposed between the secondary winding and a pair of output terminals from which an output voltage is to be outputted, the switching control unit comprising
a control circuit configured to control respective switching operations of switching devices included in at least one of the inverter circuit or the rectifying and smoothing circuit, wherein
based on a result of detection of a current flowing to pass through a capacitive component between a gate and a drain of a first switching device as one of the switching devices that is in an OFF state, the control circuit is configured to perform timing setting of a switching timing for the first switching device from the OFF state to an ON state, the switching timing being to come after a shift to a delay time occurring upon switching of a second switching device as another one of the switching devices from an ON state to an OFF state.

2. The switching control unit according to claim 1, wherein
the control circuit is configured to
detect, based on a detection timing of the current, an event of a voltage between a source and the drain of the first switching device reaching a lowest point after the shift to the delay time, in a pre-stage before the voltage reaches the lowest point, and
perform, at a time point when the event is detected, the timing setting of the switching timing for the first switching device.

3. The switching control unit according to claim 2, wherein, by performing, based on the detection timing of the current, the timing setting of the switching timing for the first switching device to the ON state, the control circuit is configured to reduce a circuit delay time from the detection of the current to switching of the first switching device to the ON state, and thereby shorten the delay time.

4. The switching control unit according to claim 3, wherein the control circuit is configured to shorten the delay time to approximately zero by reducing the circuit delay time.

5. The switching control unit according to claim 1, wherein the control circuit configured to execute first control and second control in a switchable manner in accordance with a status of the detection of the current,
the first control comprising performing the timing setting of the switching timing for the first switching device, based on the result of the detection of the current,
the second control comprising setting the switching timing for the first switching device to a fixed timing at all times.

6. The switching control unit according to claim 1, further comprising
a current detector configured to directly or indirectly detect the current.

7. The switching control unit according to claim 6, wherein the current detector is coupled to a driving transistor in the control circuit.

8. The switching control unit according to claim 1, wherein the capacitive component between the gate and the drain of the first switching device comprises a parasitic capacitance of the first switching device or an external capacitor.

9. The switching control unit according to claim 1, wherein each of the first switching device and the second switching device comprises a switching device that is disposed in the inverter circuit.

10. The switching control unit according to claim 1, wherein at least one of the first switching device or the second switching device comprises a switching device that is disposed in the rectifying and smoothing circuit and that is configured to perform synchronous rectification.

11. A switching power supply apparatus comprising:
the switching control unit according to claim 1;
the pair of input terminals;
the pair of output terminals;
the transformer;
the inverter circuit; and
the rectifying and smoothing circuit.

12. An electric power supply system comprising:
the switching power supply apparatus according to claim 11; and
a power source configured to supply the input voltage to the pair of input terminals.
